(19) United States
(12) Patent Application Publication
(10) Pub. No.: US 2024/0211452 A1
(43) Pub. Date: Jun. 27, 2024

(54) SYSTEM AND METHOD FOR IMPROVING BUILDING DATA

(71) Applicant: HERE Global B.V., Eindhoven (NL)

(72) Inventor: Priyank SAMEER, Mumbai Maharashtra (IN)

(21) Appl. No.: 18/088,315

(22) Filed: Dec. 23, 2022

(51) Int. Cl. G06F 16/215; G06F 16/23; G06F 16/29

(52) U.S. Cl. CPC G06F 16/215; G06F 16/2379; G06F 16/29

(57) ABSTRACT

The disclosure provides a system, a method and a computer program product for improving building data. The system determines a first set of building values associated with a reference building. The first set of building values includes a shifting value and an angular shifting position associated with the reference building. Further, the system, calculates a second set of building values for the plurality of buildings present within a predefined area of the reference building. Further, the second set of building values are calculated based on the determined first set of building values and a respective determined height of each building of the plurality of buildings. Further, the system, improves the building data associated with the plurality of buildings stored in a map database, based on the calculated second set of building values.

### TECHNOLOGICAL FIELD

The present disclosure relates to accurate building base detection and more particularly relates to a system and a method for improving building base data for a map database.

### BACKGROUND

With recent advancements in navigation systems, there has been significant development of maps. The maps may be utilized in various devices, such as computers, vehicle infotainment systems, and smart phones. The maps may provide navigation directions using satellite imagery and geospatial technology. The maps may include various types of information such as lane information, building data (such as geographical locations), construction zones, road closures and the like.

Typically, detection of accurate position (such as geographical coordinates) of a base of the building included in the building data is required for a variety of applications, such as for the accurate development of the maps and navigation of autonomous or semi-autonomous vehicles. For detection of accurate geographical coordinates of the base of the building, imaging devices may be utilized. For example, an aerial image or a satellite image of the building may be captured to detect the base of the building.

Conventionally, the aerial images captured using drones or the satellite images captured using satellites are at a certain angle with respect to the buildings. Thus, a position of the base of the building that may be identified using the aerial images or the satellite images may be inaccurate as compared to an actual base position of the building on a ground. As the detection of the geographical coordinates of the actual base position of the building is required, the inaccurate base position of the building identified using the aerial images or the satellite images needs to be corrected.

Moreover, in most of the scenarios (such as 90% of the cases), the base of the building is not visible in the aerial or satellite images of the building. In such scenarios, “Light detection and Ranging (LiDAR)” sensor may be utilized to detect the actual base position of the building on the ground. The detection of the actual base position using the LiDAR sensor may require moving the LiDAR sensor around the building. The LiDAR generates data, such as a three-dimensional (3D) point cloud data that may be utilized to detect the actual position of the base of the building. However, the generation of the 3D point cloud data using the LiDAR sensor for a plurality of buildings may be labor intensive, time consuming and computationally expensive process.

Therefore, there is a need for improved system and method for detecting accurate base of the building to improve the building data.

### BRIEF SUMMARY

A system, a method and a computer programmable product are provided for improving building data of a plurality of buildings.

In one aspect, a system for improving building data of a plurality of buildings is disclosed. The system comprises at least one non-transitory memory configured to store computer-executable instructions and at least one processor configured to execute the computer-executable instructions to determine a first set of building values associated with a reference building. The first set of building values are determined based on at least a first set of images and a second set of images associated with the reference building. The first set of building values includes at least a shifting value and an angular shifting position associated with the reference building. Also, the at least one processor is configured to calculate a second set of building values for each of the plurality of buildings present within a predefined area of the reference building based on the determined first set of building values, and a respective determined height of each of the plurality of buildings. Further the building data is improved associated with each of the plurality of buildings stored in a map database, based on the calculated second set of building values.

In additional system embodiments, the shifting value indicates height per unit data required to correct a base position of each of the plurality of buildings included in the building data associated with the plurality of buildings. Further, the angular shifting position indicates an amount of an angular shift required to correct the base position of each of the plurality of buildings included in the building data.

In additional system embodiments, the at least one processor is further configured to receive the first set of images from at least one of: an aerial imaging device or a satellite-based imaging device. Further, the received first set of images includes at least a top view of the reference building.

In additional system embodiments, the at least one processor is further configured to receive the second set of images from at least one of: a street-level based imaging device or a light detection and ranging (LiDAR) system. Further, the second set of images includes at least a side view or a front view of the reference building.

In additional system embodiments, the at least one processor is further configured to identify geographical coordinates of a roof of the reference building based on the first set of images. In addition, the processor is configured to determine the first base position of the reference building based on the identified geographical coordinates of the roof of the building.

In additional system embodiments, the at least one processor is configured to determine the shifting value based on a distance between the first base position of the reference building and a second base position of the reference building determined based on the second set of images and a height of the reference building.

In additional system embodiments, the at least one processor is further configured to utilize one or more geographical information system tools to calculate the distance between the first base position of the reference building and the second base position of the reference building determined based on the second set of images.

In additional system embodiments, the at least one processor is further configured to determine the angular shifting position based on an angle between the first base position and the second base position of the reference building.

In additional system embodiments, the at least one processor is configured to determine the height of the reference building based on retrieval of height information of the reference building from the map database.

In additional system embodiments, the calculated second set of building values for the plurality of buildings comprises at least one of: a base distance required to correct the base position of each of the plurality of buildings in the building data and the angular shifting position required to correct the base position of each of the plurality of buildings in the building data.

In additional system embodiments, the at least one processor is further configured to calculate the base distance for each building of the plurality of buildings based on the shifting value and a respective height of each building of the plurality of buildings.

In additional system embodiments, the at least one processor is further configured to select the reference building for improving the building data of the plurality of buildings, based on at least a geometry of the reference building determined from the first set of images.

In another aspect, a method for improving building data of a plurality of buildings. The method comprises determining a first set of building values associated with a reference building based on at least a first set of images and a second set of images associated with the reference building. Further, the first set of building values includes at least a shifting value and an angular shifting position associated with the reference building. Further, the method includes calculating a second set of building values for each of the plurality of buildings present within a predefined area of the reference building, based on the determined first set of building values, and a respective determined height of each of the plurality of buildings. Further, the method includes improving the building data associated with each of the plurality of buildings stored in a map database, based on the calculated second set of building values.

In additional method embodiments, the method includes receiving the first set of images from at least one of: an aerial imaging device or a satellite-based imaging device. Further, the received first set of images includes at least a top view of the reference building. Further, the method includes receiving the second set of images from at least one of: a street-level based imaging device or a light detection and ranging (LiDAR) system. The second set of images comprises at least a side view or a front view of the reference building.

In additional method embodiments, the method includes utilizing one or more geographical information system tools to calculate the distance between the first base position of the reference building and the second base position of the reference building determined based on the second set of images.

In additional method embodiments, the method includes determining the height of the reference building based on retrieval of height information of the reference building from the map database.

In yet another aspect, a computer programmable product comprising a non-transitory computer readable medium having stored thereon computer executable instruction which when executed by one or more processor, cause the one or more processors to carry out operations for improving building data of a plurality of buildings. The operations include determining a first set of building values associated with a reference building based on at least a first set of images and a second set of images associated with the reference building. Further, the first set of building values includes at least a shifting value and an angular shifting position associated with the reference building. Further, the operations include calculating a second set of building values for each of the plurality of buildings present within a predefined area of the reference building, based on the determined first set of building values, and a respective determined height of each building of the plurality of buildings. Further, the operations include improving the building data associated with each of the plurality of buildings stored in a map database, based on the calculated second set of building values.

### BRIEF DESCRIPTION OF THE DRAWINGS

Having thus described example embodiments of the disclosure in general terms, reference will now be made to the accompanying drawings, which are not necessarily drawn to scale, and wherein;

FIG. 1 illustrates a network environment of a system for improving building data, in accordance with an example embodiment;

FIG. 2 illustrates an exemplary diagram depicting a first image captured by an aerial or satellite-based imaging device, in accordance with an example embodiment;

FIG. 3A illustrates an exemplary diagram depicting a second image captured by a light detection and ranging system (LiDAR system), in accordance with an example embodiment;

FIG. 3B illustrates a diagram depicting determination of a first set of building values by use of the first image captured using the aerial or satellite-based imaging device and the second image captured by the LiDAR system, in accordance with an example embodiment;

FIG. 4A illustrates a diagram depicting determination of the first set of building values by use of the first image captured using the aerial or satellite-based imaging device and a second image including a perspective view of the reference building, captured using a street level-based imaging device, in accordance with an example embodiment;

FIG. 4B illustrates a diagram depicting determination of the first set of building values by use of the first image captured using the aerial or satellite-based imaging device and the second image including a front view of the reference building, captured using the street level-based imaging device, in accordance with an example embodiment;

FIG. 4C illustrates a diagram depicting distance between a first base position and a second base position associated with the reference building used to determine a shifting value, in accordance with an example embodiment;

FIG. 5 illustrates an exemplary diagram depicting adjusted of the first base position of the reference building to improve building data of the reference building, in accordance with an example embodiment;

FIG. 6 illustrates a block diagram depicting detailed steps of a method for improving building data of a plurality of buildings, in accordance with an example embodiment;

FIG. 7 illustrates a flowchart of a method for improving the building data, in accordance with an example embodiment; and

FIG. 8 illustrates a block diagram of a system for improving the building data, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “reference building” refers to a standalone building selected for improving a base position of each of a plurality of buildings, in a predefined area of the reference building. In an embodiment, the selection of the reference building may be based on at least a geometry of the reference building. For example, a building having an orthogonal roof geometry may be selected as the reference building. In another example, the building having at least two sides visible may be selected as the reference building.

The term “building data” may include information such as geographical coordinates of base of the buildings. For example, the building data may include the geographical coordinates of a position of the base of the plurality of buildings. The building data may further include information, such as height data of the plurality of buildings, geometrical information of the plurality of buildings, digital representation of the plurality of buildings and so forth.

### End of Definitions

A system, a method, and a computer program product are provided herein in accordance with an example embodiment for improving building data. The system disclosed herein enables determination of a first set of building values associated with a reference building based on a first set of images and a second set of images. In addition, the system disclosed herein enables calculation of a second set of building values for each of a plurality of buildings present within a predefined area of the reference building, based on determined first set of building values. Specifically, the system disclosed herein is configured to improve building data associated with each of the plurality of buildings stored in a map database, based on the calculated second set of building values.

The system, disclosed herein may be configured to receive the first set of images from at least one of an aerial imaging device or a satellite-based imaging device. The received first set of images includes a top view of the reference building. The first set of images of the reference building is used to determine roof coordinates of the reference building. The roof coordinates of the building are further used to determine a position (coordinates) of a base of the building. In an embodiment, the position of the base of the reference building is determined by adjusting the coordinates of the roof of the building to a ground level.

However, the position of the base of the reference building determined using the first set of images may be inaccurate as compared to an actual position of the base of the building on a ground. This is due to the fact that the first set of images captured using drones or satellites are at a certain angle with respect to the buildings.

As the accurate position of the base of the reference building is required, the system may use “Light detection and Ranging system (LiDAR) sensor” to detect the actual position of the base of the reference building on the ground. The detection of the actual position of the base from the LiDAR requires movement of the LiDAR sensor around the reference building at different locations. The LiDAR generates data (a second set of images), such as a three-dimensional (3D) point cloud data that may be utilized to detect the actual position of the base of the building. In an embodiment, autonomous vehicle with LiDAR sensor is used to determine the actual position of the base of the reference building. The system is configured to utilize the LiDAR to capture the second set of images associated only with the reference building. In an embodiment, the second set of images includes street level imagery of the reference building captured using an autonomous vehicle. The street level imagery is further processed to detect the actual position of the base of the reference building.

Using LiDAR just for capturing the second set of images associated with the reference building makes the system cost efficient. Further, the system utilizes both the first set of images and the second set of images to calculate the second set of building values. Based on the calculated second set of building values, the system is configured to improve the building data for each of the plurality of buildings.

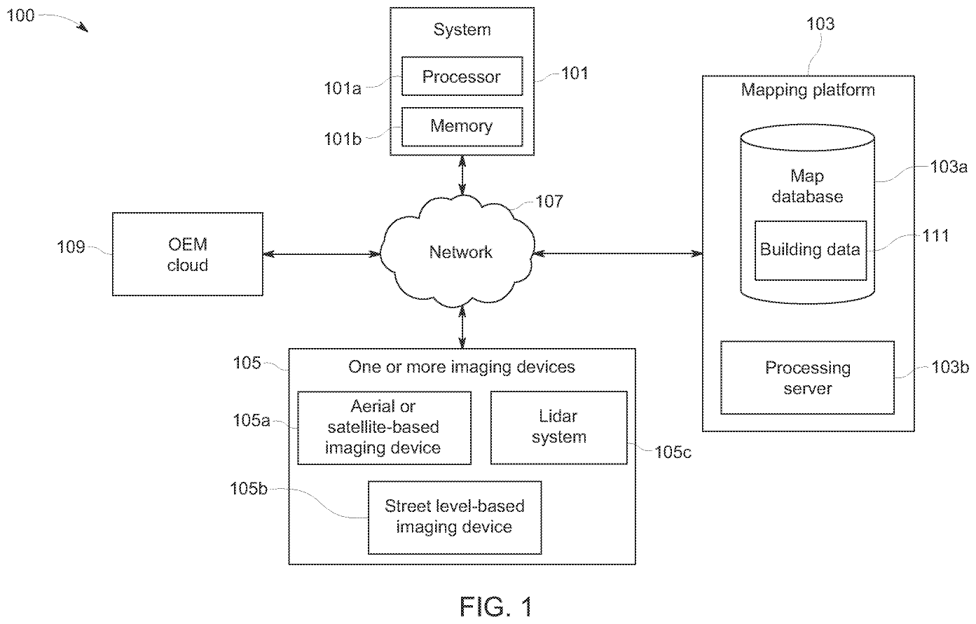

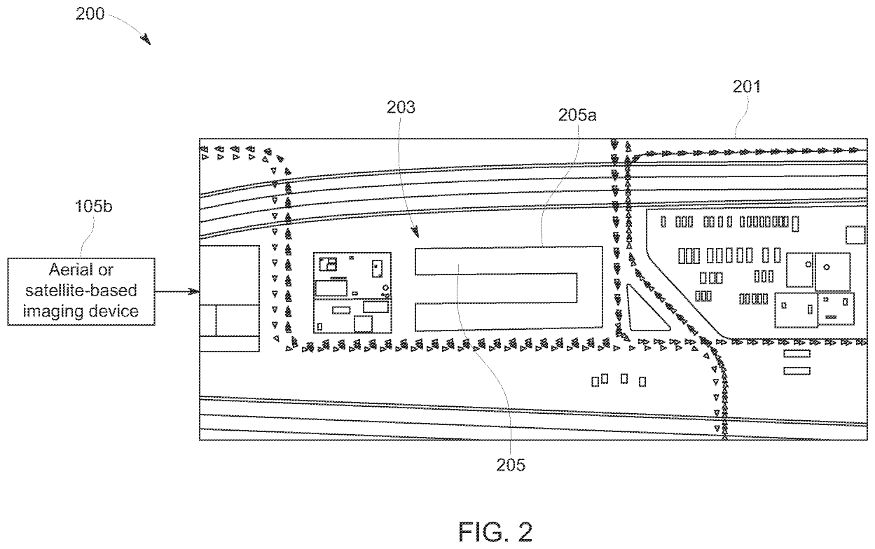

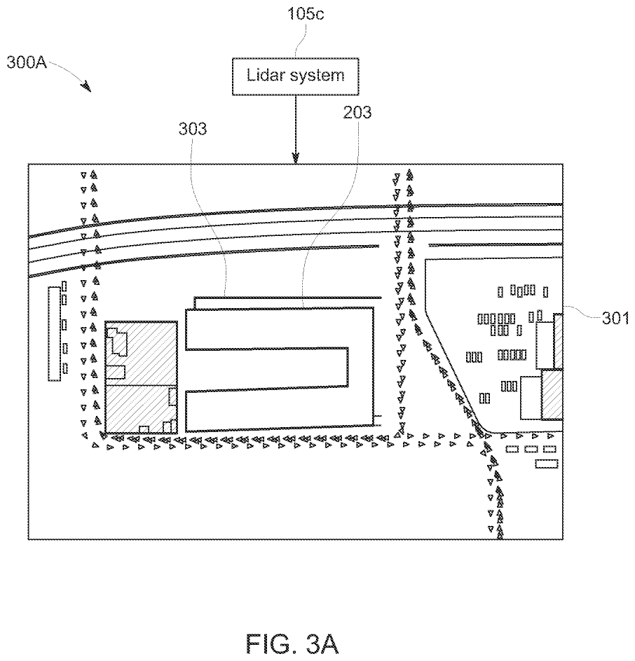

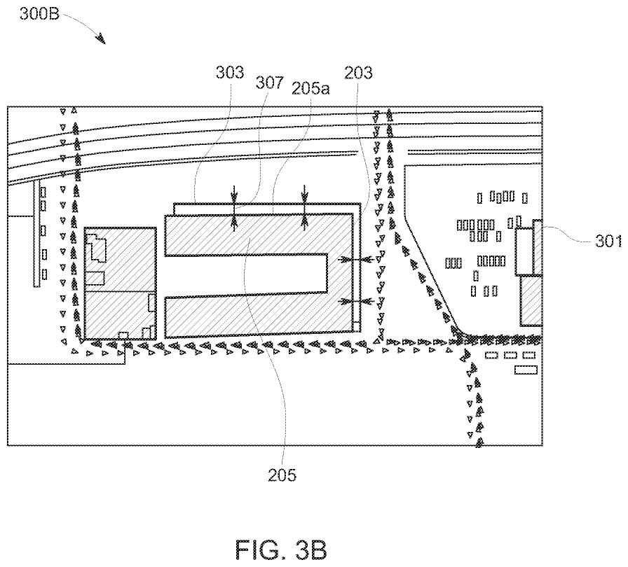

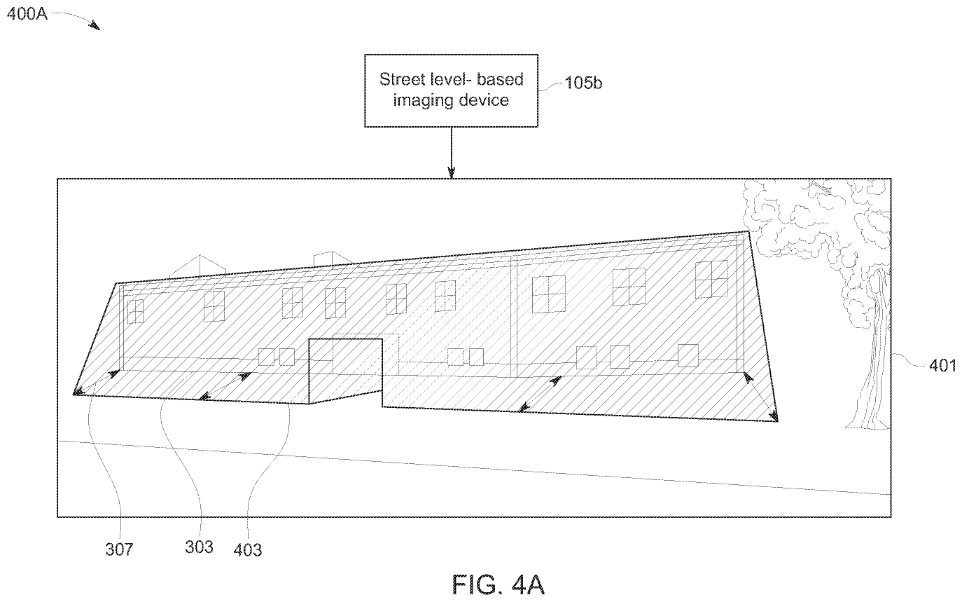

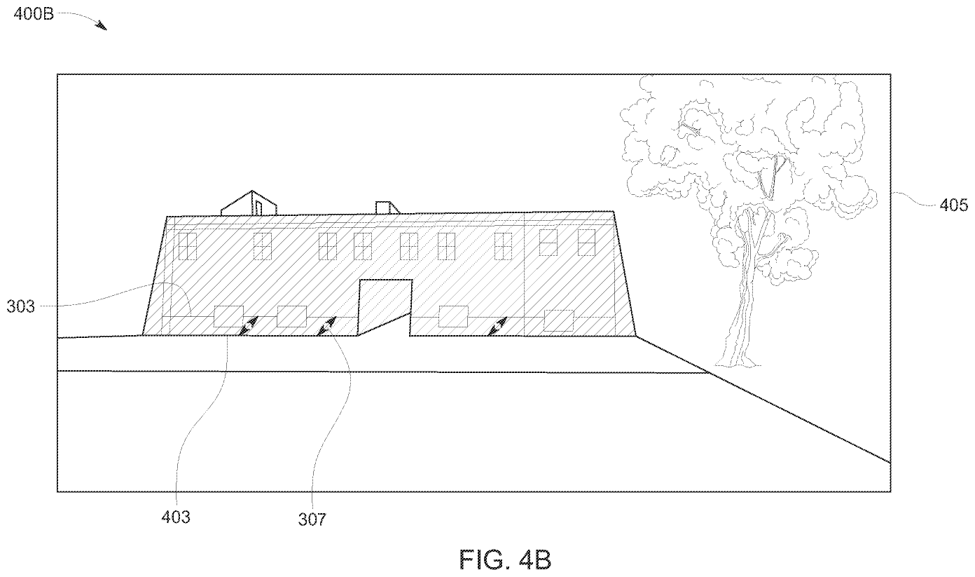

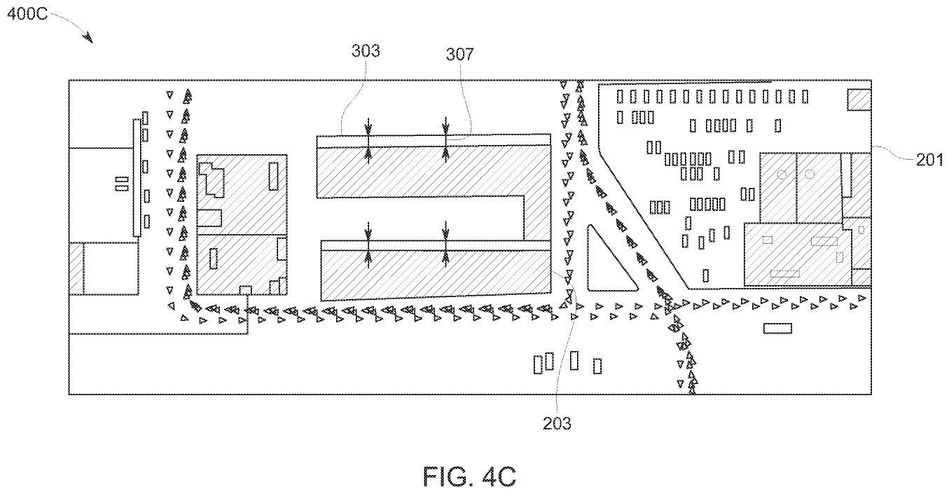

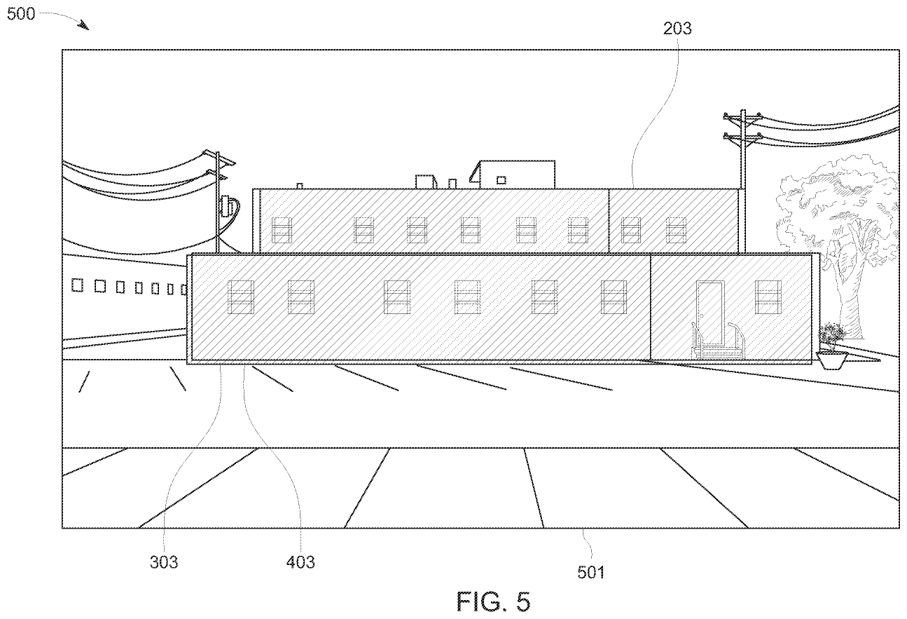

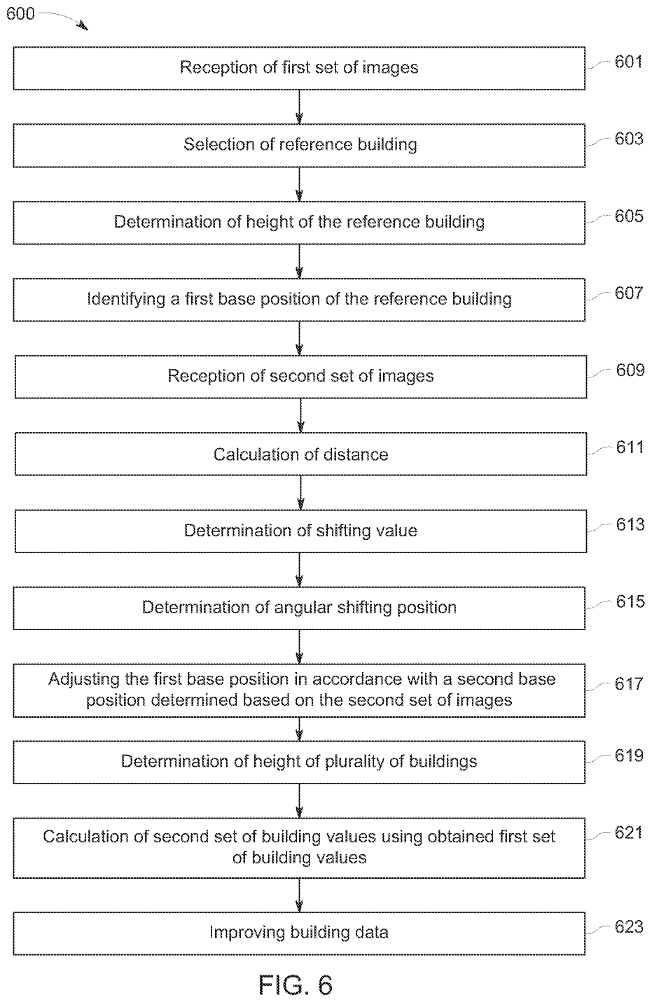

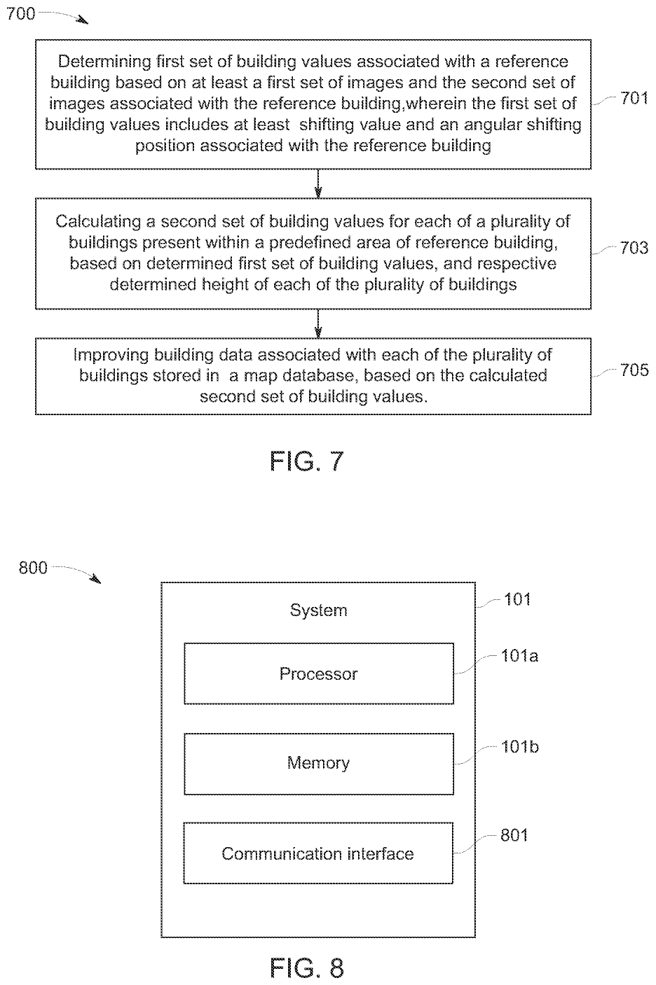

The system, the method, and the computer program product facilitating the improvement of the building data in an improved manner are described with reference to FIG. 1, FIG. 2, FIG. 3A, FIG. 3B, FIG. 4A, FIG. 4B, FIG. 4C, FIG. 5, FIG. 6, FIG. 7, and FIG. 8 as detailed below

FIG. 1 illustrates a network environment 100 of a system 101 for improving building data of a plurality of buildings, in accordance with an example embodiment. The system 101 may be communicatively coupled to a mapping platform 103, one or more imaging devices 105 and an OEM (Original Equipment Manufacturer) cloud 109 via a network 107. Additional, different, or fewer components may be provided.

The system 101 may be implemented in the one or more imaging devices 105. Further, in one embodiment, the system 101 may be a standalone unit configured to calculate a second set of building values associated with the each of the plurality of buildings based on aerial imagery and street-level imagery of the building. Alternatively, the system 101 may be coupled with an external device such as the one or more imaging devices 105.

The system 101 may be configured to perform in operation, such as utilizing a first set of images and a second set of images to determine a first set of building values associated with a reference building. The first set of images includes top view of the reference building. The second set of images includes at least a side view and a front view of the reference building. The first set of building values includes at least a shifting value and an angular shifting position associated with the reference building. In addition, the system is configured to calculate a second set of building values for each of the plurality of buildings present within a predefined area of the reference building, based on the determined first set of building values and a respective height of each building of the plurality of buildings. The second set of building values comprises at least one of a base distance required to be corrected at a base position of each of the plurality of buildings in a building data 111, and an angular shifting position required to correct a base position of each of the plurality of buildings in the building data 111. The system 101 may be configured to improve the building data associated with the plurality of buildings stored in a map database 103a, based on the calculated second set of building values. The one or more operations of the system 101 are further described in detail, for example, in FIG. 6.

The system 101 includes at least one processor 101a (hereinafter, referred to as “processor 101A”), and memory 101B. The processor 101A may retrieve computer program code instructions that may be stored in the memory 101B for execution of the computer program code instructions. The system 101 is communicatively coupled to the mapping platform 103. The mapping platform 103 may further include the map database 103a including the building data 111 and a processing server 103b. Generally, building data may include information about the location and extent of the building (e.g. coordinates for each corner of the building), type of building, geometry of building and/or a building footprint. In an embodiment, the building data 111 may include information such as geographical coordinates of the base position of each of the plurality of buildings. For example, the building data 111 may include the geographical coordinates of a position of the base of the plurality of buildings. The building data 111 may further include information, such as height data of the plurality of buildings, geometrical information of the plurality of buildings, digital representation of the plurality of buildings and so forth. The geometrical information of the plurality of buildings may include a shape information and a size information for each of the plurality of buildings. For example, the shape information of a building may include a shape of a roof of the building and a shape of walls of the building. In another example, the size information of the building may include dimensions such as a height, a length and a breadth of the building.

The system 101 is associated with the one or more imaging devices 105. The one or more imaging devices 105 is configured to capture the first set of images and the second set of images associated with the reference building. The reference building is a standalone building selected for improving the building data 111 of the plurality of buildings in a predefined area of the reference building. In an embodiment, the selection of the reference building may be based on at least a geometry of the reference building (the geometrical information as explained above). For example, a building having an orthogonal roof geometry may be selected as the reference building. In another example, the building having at least two sides visible may be selected as the reference building. In addition, the one or more imaging devices 105 includes but may not be limited to aerial or satellite-based imaging device 105a, a street level-based imaging device 105b, and a light detection and ranging system (hereinafter, LiDAR system) 105c.

The aerial or satellite-based imaging device 105a captures the first set of images associated with the reference building. The processor 101a is configured to receive the first set of images from the aerial or satellite imaging device 105a of the one or more imaging devices 105. The first set of images may include at least a top view of the reference building. The aerial or satellite imaging device 105a may include at least one of or a combination of an unmanned aerial vehicle (UAVs) camera, a satellite camera and the like. Based on the first set of images, the processor 101a is configured to identify geographical coordinates of a roof (not shown in FIG. 1) of the reference building (further explained in FIG. 2). In addition, the processor 101a is configured to determine a first base position (shown in FIG. 4A) of the reference building based on the identified geographical coordinates of the roof of the reference building. For example, the processor 101a determines the first base position by adjusting the identified geographical coordinates of the roof of the reference building to a ground level.

Further, the processor 101a is configured to receive the second set of images from at least one of or a combination of the street-level based imaging device 105b and the LiDAR system 105c. The street-level based imaging device 105b and the LiDAR system 105c are configured to capture the second set of images associated with the reference building. The second set of images may include at least a side view or a front view of the reference building. The second set of images are utilized to determine a second base position (shown in FIG. 3A) associated with the reference building. The second base position corresponds to an actual base position of the reference building.

The processor 101a is further configured to determine the first set of building values associated with the reference building based on the first set of images and the second set of images captured by the one or more imaging devices 105, as described above. In an example, the first set of building values includes at least a shifting value and an angular shifting position associated with the reference building. The shifting value indicates height per unit data required to correct the base position of each of the plurality of buildings included in the building data associated with the plurality of buildings. The angular shifting position indicates an amount of an angular shift required to correct the base position of each of the plurality of buildings included in the building data 111. For example, the angular shifting position indicates a shift value in a specified direction that is required to correct the base position of the reference building.

The processor 101A is configured to determine the shifting value based on a distance shifted between the first base position of the reference building and the second base position of the reference building determined based on the second set of images and the height of the reference building. In an embodiment, the processor 101A is configured to fetch the height of the reference building based on retrieval of height information of the reference building from the map database 103a. The height of the reference building is stored in the map database 103a. In an exemplary embodiment, the height of the reference building may be determined using shadow data of the reference building stored in the map database 103a. The shadow data includes data associated with shadow of the reference building. The shadow may have a shape or outline that varies significantly from the corresponding shape or outline of the reference building. These variations may be due to a variety of factors including shadow cast by other objects proximate to the reference building such as trees, shrubs, vehicles or the like.

Further, the processor 101a is configured to calculate a second set of building values for the plurality of buildings present within a predefined area of the reference building, based on the determined first set of building values i.e., shifting value and angular shifting position and a respective determined height of each of the plurality of buildings. In an embodiment, the predefined area may be in a range of around 3 sq km to 5 sq km. In another embodiment, the range of the predefined area may vary. The calculated second set of building values for the plurality of buildings comprises at least one of: a base distance required to be corrected at the base position of each of the plurality of buildings in the building data 111, and the angular shifting position required to correct the base position of each of the plurality of buildings in the building data 111. In an example, the processor 101a is configured to calculate the base distance included in the second set of building values for each of the plurality of buildings, by multiplying the shifting value with a respective determined height for a particular building of the plurality of buildings. In an embodiment, the height of each of the plurality of buildings is stored in the map database 103a.

The processor 101a is further configured to improve the building data 111 associated with each of the plurality of buildings based on the calculated second set of building values. The building data 111 is improved by making a correction to coordinates of base of each building of the plurality of buildings whose base position is shifted and incorrect. The mathematical correction corresponds to shifting value and angular shifting value identified based on the reference building data and height information of each of the plurality of buildings, as briefly described above. The result of improving the building data 111 is updated coordinates of base of each of the plurality of buildings which are then stored as the updated building data 111 in the map database 103a. This results in storing of accurate building data 111 subject to improvement based on reference building.

FIG. 2 illustrates an exemplary diagram 200 of a first image 201 captured by the aerial or satellite-based imaging device 105b, in accordance with an example embodiment. The first image 201 may be for example, included in the first set of images captured by the aerial or satellite-based imaging device 105b. In some embodiments, the received first set of images, such as the first image 201 may include at least a top view of a reference building 203. The reference building 203 corresponds to the reference building explained in FIG. 1. The first image 201 may depict the top view of the reference building 203 captured from the aerial or satellite-based imaging device 105a. The reference building 203 may include a roof 205. Moreover, the first image 201 depicts an edge 205a of the roof 205.

As depicted in the exemplary diagram 200, the base of the reference building 203 may be invisible in the first image 201 as the first image 201 captures the top view of the reference building 203. In an embodiment, the first image 201 may further capture other buildings, such as a plurality of buildings near the reference building 203. For example, the aerial or satellite-based imaging device 105b may capture the first image 201 from a height, thus, the aerial or satellite-based imaging device 105b enables capturing of the plurality of buildings along with the reference building 203 in the first image 201.

In some embodiments, the processor 101a may be configured to select the reference building 203 for improving the building data of the plurality of buildings based on at least the geometry of the reference building 203 determined from the first set of images, such as the first image 201 of the first set of images. The geometry of the reference building may include a shape and a size of the reference building 203. For example, the shape of the reference building may include a shape of the roof 205 of the reference building 203 and a shape of walls of the reference building 203. In another example, the size of the reference building 203 may include dimensions such as a height, a length and a breadth of the reference building 203. In an embodiment, the reference building 203 has an orthogonal shape and hence it is assumed that the roof 205 may align with an actual base of the reference building 203 at ground level. In general, an orthogonal shape is a polygon, or a polyhedron enclosed by axis-aligned edges or faces. The reference building 203 may refer to a standalone building that is visible from at least its two sides. The visibility of the reference building 203 from at least two sides allows the street level imaging device to capture the second set of images for the reference building.

In some embodiments, the processor 101a may be configured to identify the geographical coordinates of the roof 205 of the reference building 203 based on the first set of images (such as first image 201). In addition, the processor 101a is configured to determine the first base position (shown in FIG. 4A) of the reference building 203 based on the identified geographical coordinates of the roof 205 of the reference building 203. The processor 101a determines the first base position by moving down the identified geographical coordinates of the roof 205 to a ground level. The geographical coordinates of the roof of the reference building 203 may include latitudinal coordinates, longitudinal coordinates, elevation and the like. The first base position is inaccurate as the first set of images captured using drones or satellites are at the certain angle with respect to the reference building (the second base position of the reference building 203 depicted in FIG. 3A). Hence, the second set of images is utilized to determine the second base position of the reference building 203 (further explained in FIG. 3).

FIG. 3A illustrates an exemplary diagram 300A of an image 301 captured by the LiDAR system 105c, in accordance with an example embodiment. The second image 301 may include the reference building 203. In an embodiment, the second image 301 may be included in the second set of images captured by the LiDAR system 105c.

In some embodiments, the second set of images, such as the second image 301 may include at least a side view or a front view of the reference building 203. The LiDAR system 105c may generate a three-dimensional (3D) representation of the reference building 203 based on an acquired 3D point cloud data of the reference building 203. The 3D representation may depict, for example, dimensions of the reference building 203 from different views, such as the side view, the front view and the top view of the reference building 203. In an embodiment, the LiDAR system 105c captures the second set of images of the reference building 203. In an embodiment, autonomous vehicles are used to capture street-level imagery of the reference building 203 to generate the second set of images of the reference building 203.

For example, the second image 301 may depict the roof of the reference building 203 and a second base position 303 of the reference building 203. Thus, the second image 301 may be utilized to determine an actual base position (such as the second base position 303) on a ground of the reference building 203. The first image 201 and the second image 301 may be utilized to determine the first set of building values associated with the reference building 203. The determination of the first set of building values associated with the reference building 203 by use of the first image 201 obtained from the aerial or satellite-based imaging device 105b and the second image 301 obtained from the LiDAR system 105c is further described, for example, in FIG. 3B.

FIG. 3B illustrates a diagram 300B of the second image 301 depicting determination of the first set of building values by use of the first image 201 captured using the aerial or satellite-based imaging device 105a and the second image 301 captured by the LiDAR system 105c or street-level imagery, in accordance with an example embodiment.

The diagram 300B includes the second image 301. The second image 301 includes the second base position 303 (such as the accurate base position) of the reference building 203. Moreover, the roof 205 of the reference building 203 detected in the first image 201 is shown over on the reference building 203. The diagram 300B shows the edge 205a of the roof 205 of the reference building 203 detected in the first image 201. The first base position (not shown in FIG. 3B) is determined based on the identified geographical coordinates of the roof 205 as described in FIG. 2.

The processor 101a may be further configured to determine the first set of building values associated with the reference building 203 based on at least the first image 201 of the first set of images and the second image 301 of the second set of images associated with the reference building 203. The first set of building values may include at least a shifting value and an angular shifting position associated with the reference building 203.

In some embodiments, the shifting value may indicate height per unit data required to correct a base position of each of the plurality of buildings included in the building data associated with the plurality of buildings. The shifting value included in the first set of building values may be determined based on a distance 307 and a height of the reference building 203. Determination of the shifting value is further shown in Table 1.

In some embodiments, the first set of building values may further include the distance 307 between the first base position of the reference building 203 determined based on the first image 201 and the second base position 303 of the reference building 203 determined based on the second image 301. The distance 307 may indicate a linear shift required to adjust the first base position of the reference building 203 based on the second base position 303 of the reference building 203. For example, the first base position of the reference building 203 may be updated based on the second base position 303 of the reference building 203.

In some embodiments, the processor 101a may be further configured to utilize one or more geographical information system tools to calculate the distance 307 between the first base position (along the edge 205a) of the reference building 203 and the second base position 303 of the reference building 203. The geographical information system tools may include a geographical database that may be used to determine the geographical coordinates of the first base position of the reference building 203 and the second base position 303 of the reference building 203. Moreover, the geographical information system tools may be used to linearly shift the first base position of the reference building 203 towards the second base position 303 of the reference building 203. The amount of the linear shift required to make the first base position to come in contact with the second base position 303 may be determined as the distance 307 between the first base position of the reference building 203 and the second base position 303 of the reference building 203. Thus, in such a manner, the processor 101a may determine the distance 307 between the first base position of the reference building 203 and the second base position 303 of the reference building 203.

In some embodiments, the processor 101a may be further configured to determine the height of the reference building 203 based on retrieval of height information of the reference building 203 from the map database 103a. The height of the reference building 203 may be stored in the map database 103a. The processor 101a may communicate with the map database 103a via the network 107 to retrieve the height information of the reference building 203.

In some embodiments, shadow data of the reference building 203 may be stored in the map database 103a. The processor 101a retrieve the shadow data of the reference building 203 from the map database 103a. Based on the retrieved shadow data, the processor 101a may be further configured to determine the height of the reference building 203.

TABLE 1
First set of building values associated with the reference building 203
The determination of the shifting value and the angular shifting position
associated with the reference building 203 is shown in Table 1: First set of
building values associated with the reference Building 203)

| | Height of | | |
|---|---|---|---|
| Distance 307 | the | | |
| between first base | reference | | |
| position and the | building | | |
| second base position | 203 | Angular shifting position | Shifting value |
| 303 (in meters) | (meters) | (at z level) | (height/meter) |
| X | Y | Z | X/Y |

Table 1 shows the first set of building values associated with the reference building 203. The distance 307 is represented as “X”, the height of the reference building 203 is represented as “Y”, and the angular shifting position is represented as “Z”.

The processor 101a may be configured to apply an algorithm (e.g., a mathematical algorithm) on the determined distance 307 (X) and the height (Y) of the reference building 203 to determine the shifting value. In an exemplary scenario, the algorithm may be used to divide a value of the distance 307 by a value of the height of the reference building 203 to determine the shifting value as shown in Table 1.

In an exemplary scenario, the determined distance 307 (X) may be 5 meters. The height (Y) of the reference building 203 may be 20 meters. The processor 101a may divide the value of 5 meters by the value 20 meters (5/20) to determine the shifting value as 0.25.

Moreover, the angular shifting position (Z) may indicate an amount of an angular shift required to correct the first base position of the reference building 203 and the base position of each of the plurality of buildings included in the building data 111. In some embodiments, the processor 101a may be further configured to determine the angular shifting position based on an angle between the first base position and the second base position 303 of the reference building 203. For example, first base position of the reference building 203 may be at the angle with respect to the second base position 303 of the reference building 203. The processor 101a may determine the angle and a direction of the first base position with respect to the second base position 303.

In an exemplary scenario, the second base position 303 may be 35 degrees towards northeast direction as compared to the first base position. In such a case, the processor 101a may shift the first base position at the angle of 35 degrees towards northeast direction to update the first base position.

Therefore, by utilization of the distance 307 between the first base position and the second base position 303 of the reference building 203 and the height of the reference building 203, the processor 101a may determine the shifting value included in the first set of building values. Moreover, by utilization of the angle between the first base position and the second base position 303 of the reference building 203, the processor 101a may determine the angular shifting position included in the first set of building values.

Furthermore, the determination of the first set of building values by use of the first image 201 obtained from the aerial imaging device or a satellite-based imaging device 105a and the second image obtained from the street-level based imaging device 105b is further described in FIG. 4A, FIG. 4B and FIG. 4C

FIG. 4A illustrates a diagram 400A depicting determination of the first set of building values by use of the first image 201 captured using the aerial or satellite-based imaging device 105a and a second image 401 including a perspective view of the reference building 203, captured using the street level-based imaging device 105b, in accordance with an example embodiment. The diagram 400A may include the street level-based imaging device 105b and the second image 401 including the perspective view (or a side view) of the reference building 203.

The second image 401 may be received from, for example, the street level-based imaging device 105b installed on the autonomous vehicle. The second image 401 may be utilized to determine the second base position 303 (such as the accurate base on the ground) of the reference building 203. In an example, as the usage of the LiDAR system 105c may be expensive, the street level-based imaging device 105b may be utilized to determine the second base position 303 of the reference building 203. In another example, the LiDAR system 105c may be unavailable, in such a case, the street level-based imaging device 105b may be utilized to determine the second base position 303 of the reference building 203.

The diagram 400A further depicts a first base position 403 that may be determined by use of the first image 201 obtained from the aerial or satellite-based imaging device 105b. For example, the geographical coordinates of the roof 205 may be pulled down on the ground level, and the geographical coordinates corresponding to the edge 205a of the roof 205 may be taken as the first base position 403. The details of determination of the first base position 403 by using the geographical coordinates of the roof 205 are provided, for example, in FIG. 2.

As shown in the diagram 400A, the roof 205 of the reference building 203 captured in the first image 201 may be aligned with an actual roof of the reference building 203 captured in the second image 401. However, the first base position 403 is at a distance from the second base position 303 and tilted from the detected roof 205 of the reference building 203. Thus, the first base position 403 needs to be corrected.

The diagram 400A further depicts the distance 307 between the first base position 403 and the second base position 303 of the reference building 203. The distance 307 and the height of the reference building 203 may further be utilized to determine the shifting value associated with the reference building 203. Details of the determination of the shifting value are provided, for example, in FIG. 3B and Table 1.

The first image 201 and the second image 401 may further be utilized to determine the angular shifting position associated with the reference building 203. Thus, the processor 101a may be configured to determine the first set of building values including the shifting value and the angular shifting position by using the first image 201 and the second image 401 as described in FIG. 3B and Table 1.

An exemplary second image with a front view is depicted in FIG. 4B.

FIG. 4B is a diagram 400B depicting determination of the first set of building values by use of the first image 201 captured using the aerial or satellite-based imaging device 105a and a second image 405 including a front view of the reference building 203, captured using the street level-based imaging device 105b, in accordance with an example embodiment.

The second image 405 shows the front view of the reference building 203, that includes the second base position 303 of the reference building 203. Thus, the second base position 303 of the reference building 203 may be visible in the second image 405. Moreover, as seen in the diagram 400B, the first base position 403 of the reference building 203 is different than the second base position 303 (such as the accurate base) of the reference building 203. Thus, the processor 101a may determine the distance 307 between the first base position 403 and the second base position 303 of the reference building 203. The processor 101a may be configured to determine the first set of building values including the shifting value and the angular shifting position by using the first image 201 and the second image 403 as described in FIG. 3B and Table 1.

The determined distance 307 between the first base position 403 and the second base position 303 (such as the accurate base) of the reference building 203 is further shown with respect to the first image 201 in FIG. 4C.

FIG. 4C illustrates a diagram 400C depicting the distance 307 between the first base position 403 and the second base position 303 associated with the reference building 203 used to determine shifting value, in accordance with an example embodiment. The diagram 400C includes the first image 201. The first image 201 includes the top view of the reference building 203. As the first base position 403 determined from the first image 201 is inaccurate, the processor 101a determines the second base position 303 from the second image 403 and determine the distance 307 between the first base position 403 and the second base position 303 associated with the reference building 203. The distance 307 is utilized to determine the first set of building values.

The improvement of the building data of the reference building 203 and the determination of the second set of building values for the plurality of buildings based on the first set of building values is further described in FIG. 5.

FIG. 5 is an exemplary diagram 500 depicting adjusted first base position 403 of the reference building 203, in accordance with an example embodiment. The exemplary diagram 500 includes an image 501. The image 501 depicts the front view of the reference building 203. In an embodiment, the image 501 may be included in the second set of images. The exemplary diagram 500 further shows that the first base position 403 determined from the first image 201 and the second base position 303 determined from the second image 405 aligned.

The processor 101a may be configured to align the first base position 403 and the second base position 303 by moving the first base position 403 towards the second base position 303. The processor 101a may move the first base position 403 based on the distance 307 and the angular shifting position to correct or align the first base position 403 with the second base position 303.

The processor 101a may be further configured to calculate the second set of building values for each of the plurality of buildings present within the predefined area of the reference building 203, based on the determined first set of building values, and a respective determined height of each of the plurality of buildings. In an embodiment, the predefined area may be for example, 3 to 5 square kilometers of area surrounding the reference building 203. In another embodiment, the predefined area may be for example, an area of an entire city. Further, the height of each of the plurality of buildings may be determined based on the retrieval of the height data of the plurality of buildings from the map database 103a.

In some embodiments, the calculated second set of building values for the plurality of buildings may include at least one of a base distance required to correct a base position of each of the plurality of buildings in the building data, and the angular shifting position required to correct the base position of each of the plurality of buildings in the building data.

The base position of each building may be determined by moving the geographical coordinates of the roof of each of the plurality of buildings to the ground level. However, the base position may be incorrect (such as described in FIG. 2 for the reference building 203). Thus, the calculated second set of building values for the plurality of buildings may be utilized to correct the base position of each of the plurality of buildings. The base distance may be the linear distance required to correct the base position of each of the plurality of buildings determined by using the first image 201 or any top view image including the roof of the plurality of buildings. The second set of building values are further depicted in Table 2:

First building of the plurality of Buildings (present within 3-
5 Sq.km Range)

| Base distance for the | | |
|---|---|---|
| first building (meters) = | | |
| shifting value | Height of the | Angular shifting |
| multiplied by height | first Building | position (at z level) |
| (X/Y) *B | B | Z |

### Table 2: Second Set of Building Values for the First Building of the Plurality of Buildings

Table 2 shows the calculation of the second set of building values for the first building of the plurality of buildings. The height of the first building is represented as “B”. The shifting value is represented as XY. The angular shifting position (Z) is same as the angular shifting position (Z) determined for the reference building 203.

The processor 101a may be further configured to calculate the base distance for each building of the plurality of buildings based on the shifting value and a respective height of each building of the plurality of buildings. As shown in Table 2, the base distance for the first building may be calculated by multiplying the determined shifting value and the height of the first building.

In an exemplary scenario, the shifting value may be 0.25, and the height of the first building may be 10 meters. In such a case, the base distance for the first building may be 2.5 meters. Furthermore, the angular shifting position for the first building may same as the angular shifting position determined for the reference building 203. Thus, in such a manner, the second set of building values may be calculated for each of the plurality of buildings.

Based on the calculated second set of building values, the processor 101a may be configured to improve the building data associated with each of the plurality of buildings stored in the map database 103a. For example, the geographical coordinates of the base of each of the plurality of buildings may be updated by using the second set of building values to improve the building data associated with each of the plurality of buildings.

FIG. 6 illustrates a block diagram 600 depicting detailed steps of a method for improving building data, in accordance with an example embodiment. FIG. 6 is explained in conjunction with elements of FIGS. 1-5. It will be understood that each block of the block diagram 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 101b of the system 101, employing an embodiment of the present invention and executed by the processor 101a. As will be appreciated, any such computer program instructions may be loaded onto a computer or other programmable apparatus (for example, hardware) to produce a machine, such that the resulting computer or other programmable apparatus implements the functions specified in the blocks of the block diagram. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the block diagram 600 support combinations of means for performing the specified functions and combinations of operations for performing the specified functions for performing the specified functions. It will also be understood that one or more blocks of the diagram, and combinations of blocks in the diagram, may be implemented by special purpose hardware-based computer systems which perform the specified functions, or combinations of special purpose hardware and computer instructions. The block diagram 600 of FIG. 6 is implemented for improving the building data. Fewer, more, or different steps may be provided.

At a step 601, the method includes the reception of the first set of images. The first set of images may be associated with the aerial or satellite-based imaging device 105a. The first set of images may include at least a top view of the reference building 203. The aerial or satellite imaging device 105a may include at least one of or a combination of an unmanned aerial vehicle (UAVs), a drone and the like. (as explained in FIG. 1).

At step 603, the reference building 203 is selected from the plurality of buildings. The reference building 203 may include the standalone building, the building having its two sides visible. In one or more embodiments, the reference building 203 is selected for improving the building data 111 of each of the plurality of buildings present within the predefined area such as (3-5 sq km) of the range based on geometry of the reference building 203. The geometry of the reference building 203 may be determined from the first set of images. The geometry of the reference building 203 may include latitude and longitude coordinates of the reference building 203. The geometry of the reference building 203 may also include the shape and size of the reference building 203. In an example, the shape of the reference building 203 may include a shape of a roof of the building and a shape of walls of the building. In another example, the size of the building may include dimensions such as a height, a length and a breadth of the building 203.

At step 605, the method includes determination of height of the reference building 203 based on retrieval of height information of the reference building 203 from the map database 103a. In an embodiment, the height of the reference building may be determined using shadow data of the reference building 203 stored in the map database 103a. The shadow data includes data associated with shadow of the reference building 203. The shadow may have a shape or outline that varies significantly from the corresponding shape or outline of the reference building 203. These variations may be due to a variety of factors including shadow cast by other objects proximate to the reference building 203 such as trees, shrubs, vehicles or the like.

At step 607, the method includes identifying or determining the first base position 403 of the reference building 203. The first base position 403 is determined based on the identified geographical coordinates of the roof 205 of the reference building 203. The geographical coordinates of the roof 205 are identified based on the first set of images. The first base position 403 is determined by moving down the identified geographical coordinates of the roof 205 of the reference building 203 (using the first set of images) at a ground level along the edge 205a of the roof 205. The first base position 403 is inaccurate (as explained in FIG. 2), hence the second set of images are utilized to determine the second base position 303 that corresponds to the actual base position of the reference building 203.

At step 609, the method includes reception of the second set of images. The second set of images may include the images captured from the LiDAR system 105c and the street-level based imaging device 105b. In one or more embodiments, the street-level imaging device 105d may include the images captured from vehicle sensors such as the cameras installed in the vehicle, and the cameras installed on the roads. Based on the second set of images, the second base position 303 of the reference building is determined. The second base position 303 may corresponds to the actual base position of the reference building 203.

At step 611, the method includes calculation of a distance between the first base position of the reference building 203 and the second base position 303 of the reference building 203 determined based on the second set of images. The distance is utilized to determine the first set of building values. The first set of building values includes the shifting value and the angular shift position. The shifting value indicates height per unit data required to correct a base position of each of the plurality of buildings included in the building data 111 associated with the plurality of buildings.

At step 613, the method includes determination of the shifting value. The shifting value is determined based on the calculated distance between the first base position of the reference building 203 and the second base position 303 of the reference building 203 detected in the second set of images. In addition, the shifting value is determined based on the height of the reference building 203. In an example, the height of the reference building 203 is stored in the map database 103a. In another example, the height of the reference building 203 may be calculated using the shadow data of the reference building 203). The shadow may have a shape or outline that varies significantly from the corresponding shape or outline of the reference building 203. These variations may be due to a variety of factors including shadow cast by other objects proximate to the reference building 203 such as trees, shrubs, vehicles or the like

At step 615, the method includes determination of the angular shifting position. The angular shifting position indicates an amount of an angular shift required to correct the first base position 403 of the reference building 203 and the base position of each of the plurality of buildings included in the building data.

At step 617, the method includes adjusting the first base position 403 in accordance with the second base position 303 determined by reception of the second set of images. The processor 101a may be configured to align the first base position 403 and the second base position 303 by moving the first base position 403 towards the second base position 303. The processor 101a may move the first base position 403 based on the distance 307 and the angular shifting position to correct or align or adjust the first base position 403 with the second base position 303.

At step 619, the method includes determination of height of each of the plurality of buildings. In an example, the height may be stored in the map database 103a. At step 621, the method includes calculation of the second set of building values using the first set of building values. The second set of building values is calculated based on the determined first set of building values associated with the reference building 203, and a respective determined height of each of the plurality of buildings.

At step 623, the method includes improving the building data. The second set of building values comprises at least one of: a base distance required to correct a base position of each of the plurality of buildings in the building data, and the angular shifting position required to correct the base position of each of the plurality of buildings in the building data.

FIG. 7 illustrates a flow diagram 700 of a method for improving the building data, in accordance with an example embodiment. It will be understood that each block of the flow diagram 700 of the method may be implemented by various means, such as hardware, firmware, processor, circuitry, and/or other communication devices associated with execution of software including one or more computer program instructions. For example, one or more of the procedures described above may be embodied by computer program instructions.

The method 700 illustrated by the flowchart diagram 700 of FIG. 7 may include fewer, more, or different steps than the steps mentioned below.

At step 701, the method comprises determining the first set of building values associated with reference building 203 based on at least the first set of image and the second set of images associated with the reference building 203. The first set of building values includes at least the shifting value and the angular shifting position associated with the reference building 203. The shifting value indicates height per unit data required to correct a base position of each of the plurality of buildings included in the building data 111 associated with the plurality of buildings. The shifting value is determined based on the calculated distance between the first base position 403 of the reference building 203 and the second base position 303 of the reference building 203 detected in the second set of images. In addition, the shifting value is determined based on the height of the reference building 203. In an example, the height of the reference building 203 is stored in the map database 103a. In another example, the height of the reference building 203 may be calculated using the shadow data of the reference building 203). The shadow may have a shape or outline that varies significantly from the corresponding shape or outline of the reference building 203. These variations may be due to a variety of factors including shadow cast by other objects proximate to the reference building 203 such as trees, shrubs, vehicles or the like

Further, the angular shifting position is determined using the first set of images and the second set of images. The angular shifting position indicates an amount of an angular shift required to correct the first base position 403 of the reference building 203 and the base position of each of the plurality of buildings included in the building data.

At step 703, the method comprises calculating the second set of building values for each of the plurality of buildings present within predefined area of the reference building, based on the determined first set building values, and respective determined height of each of the building of plurality of buildings. The first set of building values may be used to calculate the second set of values for each of the building of the plurality of buildings present with the predefined area (3-5 sq km) of the range.

At step 705, the method comprises improving or correcting the building data 111 associated with the plurality of buildings stored in the map database 103a, based on the calculated second set of building values. The building data 111 correction may include the correcting of building values such as the geographical coordinates of each of the plurality of buildings present with the predefined area (3-5 sq km) of the range. Based on the calculated second set of building values, the map data is corrected for each of the plurality of buildings present in the map database 103a.

The method may be implemented using corresponding circuitry. For example, the method may be implemented by an apparatus or system comprising a processor, a memory, and a communication interface of the kind discussed in conjunction with FIG. 8.

Referring again to FIG. 1, the system 101 includes the processor 101a. The processor 101a is configured to perform some or each of the operations of the method of FIG. 7 described above in FIG. 7. The processor 101a may, for example, be configured to perform the operations (701-705) by performing hardware implemented logical functions, executing stored instructions, or executing algorithms for performing each of the operations. Alternatively, the system 101 may comprise means for performing each of the operations described above. In this regard, according to an example embodiment, examples of means for performing operations (701-705) may comprise, for example, the processor 801 which may be implemented in the system 101 and/or a device or circuit for executing instructions or executing an algorithm for processing information as described above.

In an example embodiment, the processor 101a may be in communication with the memory 101b via a bus for passing information among components coupled to the system 101. The memory 101b may be non-transitory and may include, for example, one or more volatile and/or non-volatile memories. In other words, for example, the memory 101b may be an electronic storage device (for example, a computer readable storage medium) comprising gates configured to store data (for example, bits) that may be retrievable by a machine (for example, a computing device like the processor 101a). The memory 101b may be configured to store information, data, content, applications, instructions, or the like, for enabling the apparatus to carry out various functions in accordance with an example embodiment of the present invention. For example, the memory 101b may be configured to buffer input data for processing by the processor 101a. The memory 101b may be solid-state memory, a hard disk drive (HDD), read-only memory (ROM), random-access memory (ROM), flash memory or another type of memory. For example, memory 101b may be configured to store computer program instructions which, when executed by processor 101a, cause system 101 to perform a method 700 as described in FIG. 7. As exemplarily illustrated in FIG. 1, the memory 101b may be configured to store instructions for execution by the processor 101a.

As such, whether configured by hardware or software methods, or by a combination thereof, the processor 101a may represent an entity (for example, physically embodied in circuitry) capable of performing operations according to an embodiment of the present invention while configured accordingly. Thus, for example, when the processor 801 is embodied as an ASIC, FPGA or the like, the processor 801 may be specifically configured hardware for conducting the operations described herein. Alternatively, as another example, when the processor 101a is embodied as an executor of software instructions, the instructions may specifically configure the processor 101a to perform the algorithms and/or operations described herein when the instructions are executed. However, in some cases, the processor 101a may be a processor specific device (for example, a mobile terminal or a fixed computing device) configured to employ an embodiment of the present invention by further configuration of the processor 101a by instructions for performing the algorithms and/or operations described herein. The processor 101a may include, among other things, a clock, an arithmetic logic unit (ALU) and logic gates configured to support operation of the processor 101a.

In an example embodiment, the system 101 may be embodied in one or more of several ways as per the required implementation. For example, the system 101 may be embodied as a cloud-based service or a cloud-based platform. In each of such embodiments, the system 101 may be communicatively coupled to the components shown in FIG. 1 to carry out the desired operations and wherever required modifications may be possible within the scope of the present disclosure.

The system is communicatively coupled with the mapping platform 103. The mapping platform 103 includes the map database 103a, the processing server 103b and the building data 111. The building data 111 is explained previously in FIG. 1. The map database 103a may include pre-historic building data record of the plurality of buildings. In addition, the map database 103a may include data regarding the plurality of buildings on or around a road network, for example building data records.

The processing server 103b may be one or more fixed or mobile computing device. In general, processing server is a computer program or device that provides functionality for other programs or devices. The processing server 103b provides various functionalities, such as sharing data or resources among multiple clients, or performing computation for a client. However, those skilled in the art would appreciate that the system 101 may be connected to a greater number of processing servers. The system 101 may be configured to access the map database 103a via network 105 and the processing server 103b. The network 107 includes a satellite network, a telephone network, a data network (local area network, metropolitan network, and wide area network), distributed network, and the like. In one embodiment, the network 107 is internet. In another embodiment, the network 107 is a wireless mobile network. In yet another embodiment, the network 107 is a combination of the wireless and wired network for optimum throughput of data extraction and transmission. The network 107 includes a set of channels. Each channel of the set of channels supports a finite bandwidth. The finite bandwidth of each channel of the set of channels is based on capacity of the network 107. In addition, the network 107 connects the system 101 to the mapping platform 103 using a plurality of methods. The plurality of methods used to provide network connectivity to the system 101 may include 2G, 3G, 4G, 5G, and the like.

The network connects the system 101 to the OEM cloud 109. The OEM cloud 109 may be configured to anonymize any data received from the one or more imaging devices 105, before using the data for further processing, such as before sending the data to the mapping platform 103. In some embodiments, the OEM cloud 109 includes historic data associated with the building data 111 of the plurality of buildings. The building data 111 may be improved by the system 101 to update the map database 103a of the mapping platform 103.

FIG. 8 illustrates a block diagram of the system 101, in accordance with an example embodiment. The system includes the processor 101a, the memory 101b, and a communication interface 801. The processor 101a and memory 101b is explained above in reference to FIG. 1.

In some example embodiments, the system 101 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to a user of the vehicle. In such example embodiments, the system 101 may comprise a processing means such as a central processing unit (CPU), storage means such as on-board read only memory (ROM) and random access memory (RAM), sensors such as a GPS sensor, gyroscope, a light detection and ranging (LIDAR) sensor, a proximity sensor, motion sensors such as accelerometer, a display enabled user interface such as a touch screen display, and other components as may be required for specific functionalities of system 101. Additional, different, or fewer components may be provided. For example, the system 101 may be configured to execute and run mobile applications such as a messaging application, a browser application, a navigation application, and the like. For example, system 101 may be a dedicated vehicle (or a part thereof) for gathering the building data 111. For example, the system 101 may be a consumer vehicle (or a part thereof). In some example embodiments, the system 101 may serve the dual purpose of a data gatherer and a beneficiary device. The system 101 may be configured to the building data 111 associated with a plurality of buildings in a predefined area of the reference building. In some scenarios, the system 101 may be configured to receive the building data from the one or more imaging devices 105 such as the satellite-based imaging device 105a, the LiDAR system 105c, and the street-level based imaging device 105b.

The system 101 may be accessed using the communication interface 805. The communication interface 801 may provide an interface for accessing various features and data stored in the system 101. The communication interface 805 may comprise input interface and output interface for supporting communications to and from the system 101 or any other component with which the system 101 may communicate. The communication interface 801 may be any means such as a device or circuitry embodied in either hardware or a combination of hardware and software that is configured to receive and/or transmit data to/from a communications device in communication with the system 101. In this regard, the communication interface 801 may include, for example, an antenna (or multiple antennae) and supporting hardware and/or software for enabling communications with a wireless communication network. Additionally, or alternatively, the communication interface 805 may include the circuitry for interacting with the antenna(s) to cause transmission of signals via the antenna(s) or to handle receipt of signals received via the antenna(s). In some environments, the communication interface 801 may alternatively or additionally support wired communication. As such, for example, the communication interface 801 may include a communication modem and/or other hardware and/or software for supporting communication via cable, digital subscriber line (DSL), universal serial bus (USB) or other mechanisms. In some embodiments, the communication interface 801 may enable communication with a cloud-based network to enable deep learning.

In this way, example embodiments of the invention results in validation of the correction of building data associated with the one or more imaging devices 105 of each of the plurality of buildings present within a predefined area (3-5 km) of the range. The invention may also provide determination of the accuracy level of the building data 111 based on the calculated second set of building values of each of the plurality of buildings. The invention also allows update of the map database 103a based on the calculated second set of building values.

In some example embodiments, a computer programmable product may be provided. The computer programmable product may comprise at least one non-transitory computer-readable storage medium having stored thereon computer-executable program code instructions that when executed by a computer, cause the computer to execute the method 700.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for improving building data of a plurality of buildings, the system comprising:
at least one non-transitory memory configured to store computer executable instructions; and
at least one processor configured to execute the computer executable instructions to:
determine a first set of building values associated with a reference building based on at least a first set of images and a second set of images associated with the reference building, wherein the first set of building values includes at least a shifting value and an angular shifting position associated with the reference building;
calculate a second set of building values for each of the plurality of buildings present within a predefined area of the reference building, based on the determined first set of building values, and a respective determined height of each of the plurality of buildings; and
improve the building data associated with each of the plurality of buildings stored in a map database, based on the calculated second set of building values.

2. The system of claim 1, wherein
the shifting value indicates height per unit data required to correct a base position of each of the plurality of buildings included in the building data associated with the plurality of buildings; and
the angular shifting position indicates an amount of an angular shift required to correct a first base position of the reference building and the base position of each of the plurality of buildings included in the building data.

3. The system of claim 1, wherein the at least one processor is further configured to receive the first set of images from at least one of: an aerial imaging device or a satellite-based imaging device, and wherein the received first set of images includes at least a top view of the reference building.

4. The system of claim 1, wherein the at least one processor is further configured to receive the second set of images from at least one of: a street-level based imaging device or a light detection and ranging (LiDAR) system, and wherein the second set of images includes at least a side view or a front view of the reference building.

5. The system of claim 1, wherein the at least one processor is further configured to:
identify geographical coordinates of a roof of the reference building based on the first set of images; and
determine a first base position of the reference building based on the identified geographical coordinates of the roof of the reference building.

6. The system of claim 5, wherein the at least one processor is further configured to determine the shifting value based on:
a distance between the first base position of the reference building determined based on the first set of images and a second base position of the reference building determined based on the second set of images, and
a height of the reference building.

7. The system of claim 6, wherein the at least one processor is further configured to utilize one or more geographical information system tools to calculate the distance between the first base position of the reference building and the second base position of the reference building.

8. The system of claim 6, wherein the at least one processor is further configured to determine the angular shifting position based on an angle between the first base position and the second base position of the reference building.

9. The system of claim 6, wherein the at least one processor is further configured to determine the height of the reference building based on retrieval of height information of the reference building from the map database.

10. The system of claim 1, wherein the calculated second set of building values for the plurality of buildings comprises at least one of: a base distance required to correct a base position of each of the plurality of buildings in the building data, and the angular shifting position required to correct the base position of each of the plurality of buildings in the building data.

11. The system of claim 1, wherein the at least one processor is further configured to calculate the base distance for each building of the plurality of buildings based on the shifting value and a respective height of each building of the plurality of buildings.

12. The system of claim 1, where at least one processor is further configured to select the reference building for improving the building data of the plurality of buildings, based on at least a geometry of the reference building determined from the first set of images.

13. A method for improving building data of a plurality of buildings, the method comprising:
determining a first set of building values associated with a reference building based on at least a first set of images and a second set of images associated with the reference building, wherein the first set of building values includes at least a shifting value and an angular shifting position associated with the reference building;
calculating a second set of building values for each of the plurality of buildings present within a predefined area of the reference building, based on the determined first set of building values, and a respective determined height of each of the plurality of buildings; and
improving the building data associated with each of the plurality of buildings stored in a map database, based on the calculated second set of building values.

14. The method of claim 13, further comprising receiving the first set of images from at least one of: an aerial imaging device or a satellite-based imaging device, and wherein the received first set of images includes at least a top view of the reference building.

15. The method of claim 13, further comprising receiving the second set of images from at least one of: a street-level based imaging device or a light detection and ranging (LiDAR) system, and wherein the second set of images comprises at least a side view or a front view of the reference building.

16. The method of claim 13, further comprising:
identifying geographical coordinates of a roof of the reference building based on the first set of images; and
determining a first base position of the reference building based on the identified geographical coordinates of the roof of the reference building.

17. The method of claim 13, further comprising utilizing one or more geographical information system tools to calculate the distance between the first base position of the reference building and the second base position of the reference building determined based on the second set of images.

18. The method of claim 13, further comprising determining the height of the reference building based on retrieval of height information of the reference building from the map database.

19. The method of claim 13, further comprising determining the angular shifting position based on an angle between the first base position and the second base position of the reference building.

20. A computer programmable product comprising a non-transitory computer readable medium having stored thereon computer executable instruction which when executed by one or more processors, cause the one or more processors to carry out operations for correcting building data of a plurality of buildings, the operations comprising:
determining a first set of building values associated with a reference building based on at least a first set of images and a second set of images associated with the reference building, wherein the first set of building values includes at least a shifting value and an angular shifting position associated with the reference building;
calculating a second set of building values for each of the plurality of buildings present within a predefined area of the reference building, based on the determined first set of building values, and a respective determined height of each of the plurality of buildings; and
improving the building data associated with each of the plurality of buildings stored in a map database, based on the calculated second set of building values.
